(19) United States
(12) Patent Application Publication
(10) Pub. No.: US 2007/0175813 A1
(43) Pub. Date: Aug. 2, 2007

(54) Device for supporting a rotating frame of a filtration installation

(76) Inventor: Serge Kurowski, Neuville-en-Condroz (BE)

Correspondence Address: SUGHRUE MION, PLLC, 2100 PENNSYLVANIA AVENUE, N.W., SUITE 800, WASHINGTON, DC, 20037, US

(21) Appl. No.: 10/598,684

(22) PCT Filed: Mar. 8, 2005
(86) PCT No.: PCT/EP05/51027

§ 371 Date: Sep. 8, 2006

(30) Foreign Application Priority Data
Mar. 10, 2004 (BE) 2004/0133

(51) Int. Cl. B01D 35/00

(52) U.S. Cl. 210/356

(57) ABSTRACT

The invention relates to a device for supporting the rotating frame (1) of a filtration installation comprising filter cells which are disposed in the form of a carousel. The invention comprises: support rollers (2), and a fixed bearing (11) which supports each roller such as to enable same to pivot. According to the invention, the bearing comprises a first arm and a second arm (10) which are disposed on either side of the roller. The invention is characterised in that, depending on the forces applied to the roller by the rotating frame, the first arm moves from a first bending state to a second bending state and vice versa, independently of the bending state of the second arm, and the second arm moves from a first bending state to a second bending state and vice versa, independently of the bending state of the first arm.

The present invention relates to a device supporting a rotating frame for a filtration installation with filtration cells disposed in a carousel, comprising
support rollers that each have a pivot axis and that support the rotating frame so as to allow a rotation of the latter about a rotation axis of the carousel, and
per roller, a fixed bearing that supports the roller so as to allow its pivoting, the bearing comprising a first arm and a second arm disposed on each side of the roller in order to carry it so as to allow its pivoting.

Filtration devices with filtration cells disposed in a carousel have already been known for a long time, which are in particular in use in the production of phosphoric acid, copper, cobalt, zinc, uranium, etc hydrometallurgy, the washing of active carbon or phosphates and the filtration of acids in general.

The cells in these installations are supported by a rotating frame generally comprising two rings each formed from several rails arranged one behind the other in a circular manner, these rings resting on support rollers (see in particular U.S. Pat. No. 3.389.800).

A large number rollers are necessary for supporting the frame, which in its turn supports the filtration cells, and these rollers therefore represent parts of the installation that wear relatively quickly and must therefore be replaced frequently. The result is a significant cost in maintaining the installation.

Several attempts have already been made to achieve running conditions without wear on the rollers. Improvement to the materials forming the tyre of the rollers, the use of convexity on these tyres or the production of conical rollers can in particular be cited. The results thus achieved do however still prove to be insufficient.

The aim of the present invention is to remedy the drawbacks mentioned and therefore to develop a device for supporting a rotating frame that makes it possible to reduce the wear on the support rollers.

To resolve these problems there has been provided, according to the invention, a device for supporting a rotating frame as indicated at the start, in which, according to the forces applied to the roller by the rotating frame, the first arm passes from A first bending state to a second bending state and vice versa independently of a bending state of the second arm, and respectively the second arm passes from a first bending state to a second bending state and vice versa, independently of a bending state of the first arm. When a rotating frame begins to turn, as a result of any inequalities on the rail of the rotating frame that rests on the support rollers and as a result of the different position of each of the arms of a bearing with respect to the rotation axis of the carousel, the arms of one and the same bearing are frequently and regularly subjected to unequal forces directed downwards. In the case of rigid bearing arms, the result is an overloading of the rollers and therefore deterioration in these. According to the invention, the arms of the bearings have bending capacities vis-á-vis the forces applied by the rotating frame on the rollers. Therefore, when the rotating chassis is placed on the support rollers, the arms of each bearing pass to a first bending state, normally equal for the two arms. When the frame begins to turn, each arm can pass to a second bending state that is peculiar to it, that is independent of the one that the other arm has, and that can moreover vary according to the variable forces applied by the frame on each arm. The result is therefore a very great flexibility in the support for the rollers, which preserves these and greatly delays their replacement.

According to one embodiment of the invention each of the arms of a bearing has a first end fixed to a base and a second end that carries the roller and that is situated at a distance from the base, variable according to the said forces applied to the roller. The arms of the bearing are therefore flexible per se. Advantageously, each bearing arm can have the general shape of a U on its side, the said first end and the said second end of which move closer together or further apart according to the said forces applied to the roller. If, as in this example, the arm becomes flexible through its conformation, it can also be so through its composition, for example by the use of elastic or flexible materials, such as certain steels or appropriate thermoplastic or polymerised materials.

According to another embodiment of the invention, each arm of the bearing comprises a first rigid part that carries the pivot axis and a second part that supports the said first part flexibly on a base. It would also be possible to provide the converse, a first flexible part carrying the pivot axis and a second part supporting the second part rigidly on a base.

According to one advantageous embodiment each bearing arm carries the roller so as to allow a vertical downward movement of the pivot axis of around 2 mm. Advantageously the pivot axis of the roller is horizontal in the first bending state of the arms of the bearing and in that each bearing arm carries the pivot axis of the roller so as to allow a tilting of around 2o from the horizontal.

Other embodiments of the invention are indicated in the accompanying claims.

Other details and particularities of the invention will emerge from the description given below non-limitingly and with reference to the accompanying drawings.

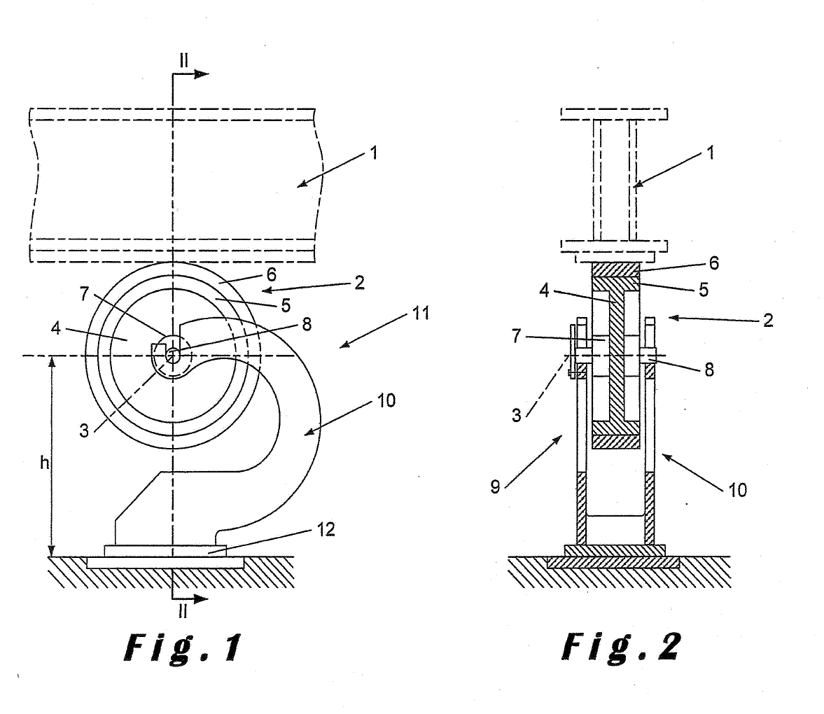

FIGS. 1 and 2 show a lateral view and respectively a view in section, along the line II-II in FIG. 1, of an embodiment of the roller support device according to the invention.

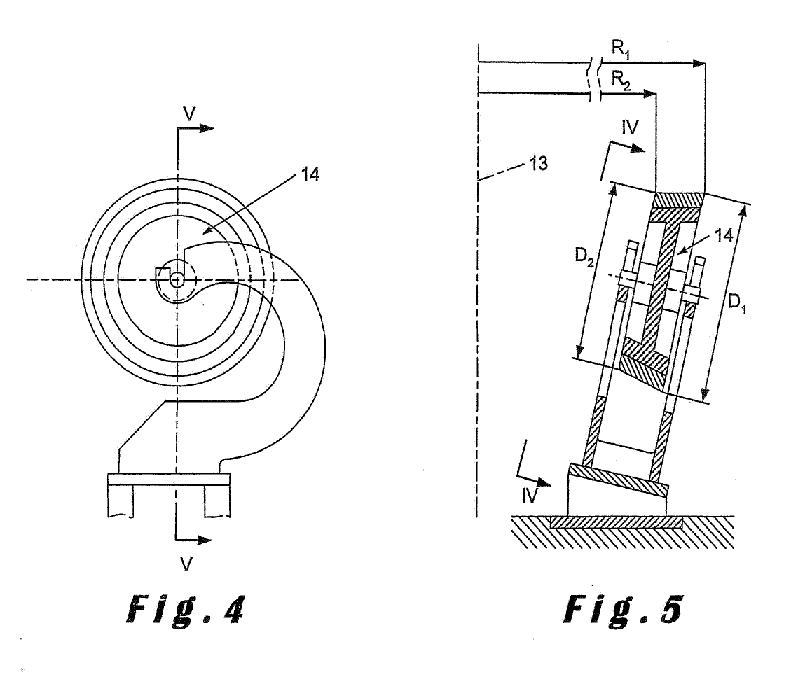

FIGS. 4 and 5 show a lateral view from the plane IV-IV in FIG. 5 and respectively a view in section along the line V-V in FIG. 4 of a variant embodiment according to the invention.

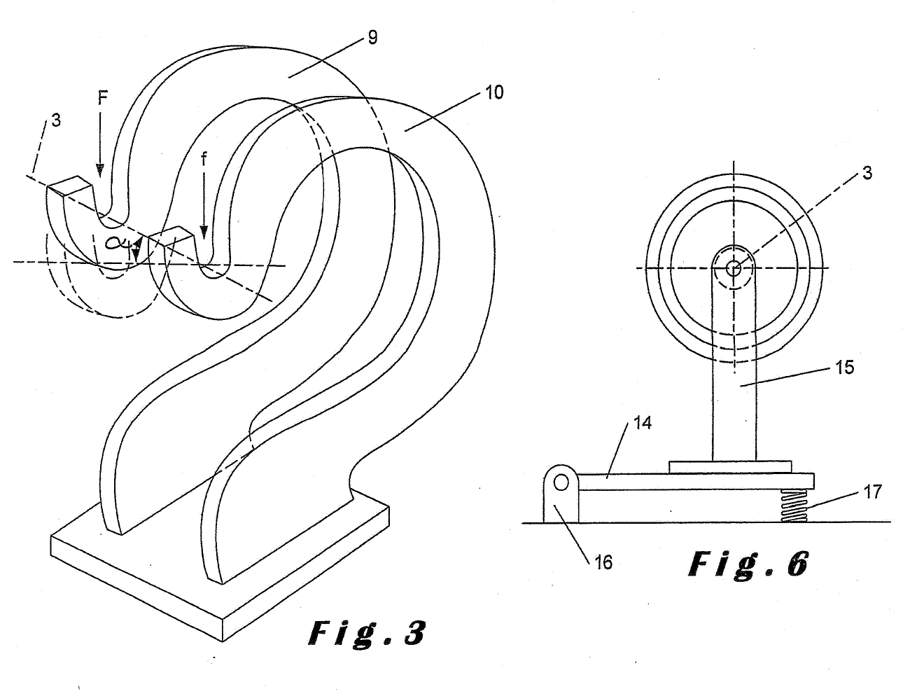

FIG. 3 depicts a perspective view of the arms of the bearing of the device illustrated in FIGS. 1 and 2.

FIG. 6 shows a lateral view of yet another variant embodiment of the invention.

FIGS. 1 and 2 depict a device supporting a rotating frame for a filtration installation with filtration cells disposed in a carousel. The rotating frame consists of a succession of rails 1 in the form of ring segments arranged one after the other in a circle. These rings formed from rails 1 rest on support rollers 2. In the example embodiment illustrated, the support roller 2 is capable of pivoting about a pivot axis 3. The roller 2 comprises a wheel 3 provided with a steel or cast iron rim 5, for example, which is here covered with a steel tyre 6. It is obviously possible to consider a roller without a tyre or provided with a tyre made from other suitable materials, for example cast iron or an appropriate synthetic material, such as polyurethane. The roller can be used dry or with lubrication.

The wheel 5 is provided at its centre with a ball bearing 7 that enables it to turn freely on a shaft 8 carried by the arms 9 and 10 of a bearing 11, disposed on each side of the roller. It is obviously possible to also envisage a shaft that turns with the wheel and that is supported by arms of the bearing so as to be able to pivot in these, for example by means of roller bearings.

At a first end of each of the arms 9 and 10, these are welded to a base plate 12, itself anchored in the ground. At their opposite end, the arms of the bearing have the form of hook open upwards in which the shaft 8 can be housed. The arms in the embodiment illustrated have the general shape of a U on its side, which gives properties of flexibility to each arm.

If, as illustrated in FIG. 1, when the frame and therefore the rail 1 is placed on the roller 2, the shaft 8, though which the pivot axis 3 passes, is situated at a distance h from the ground and is therefore in a first bending state resulting from the weight of the rotating frame and the filtration cells that it supports, as soon as the frame begins to run on the rollers each arm may undergo variable downward forces and therefore the height h may vary, the two ends of the U moving closer together or further apart according to these variable forces.

As can be seen in FIG. 3, in solid lines, the two arms of 9 and 10 of the bearing are shown in an identical bending state and the pivot axis 3 is substantially horizontal. As from the time when a force F greater than the force f, initially applied to the two arms 9 and 10, is applied solely to the arm 9, this arm of the bearing according to the invention can alone pass into a second bending state depicted in dot and dash lines in FIG. 3. Such a movement of the hook of the bearing 9 can advantageously be tolerated up to approximately 2 mm, which enables the pivot axis 3 to move away from the horizontal The axis can thus form an angle α with respect to the horizontal, ranging up to approximately 2o.

If in the embodiment illustrated in FIGS. 1 and 2 the roller 2 is cylindrical, it is obviously possible, as illustrated in FIGS. 4 and 5, to provide conical rollers 14. These rollers offer the advantage that, with respect to the rotation axis 13 of the carousal, it has a diameter D1 on the outside and a diameter D2 less than D1 on the inside, so as to obtain as far as possible a ratio

$$\frac{{D}_{1}}{{R}_{1}} = \frac{{D}_{2}}{{R}_{2}} ,$$

where R1 and R2 represents the external radius of the circle of the carousal passing through the top external edge of the roller and respectively the internal radius of the circle of the carousal passing through the top internal edge of the roller. This ratio in theory determines a bearing without wear. Apart from the slanting arrangement of the arms of the bearing, the support device illustrated here is the same as in the embodiment according to FIGS. 1 and 2.

In the embodiment illustrated in FIG. 6, only one bearing arm has been shown. This comprises a rigid part in the form of a rigid upright 15 that carries the axis 3 of roller 4 and that is supported fixedly by a lever arm 14. The lever arm 14 is supported on the ground by a pivot bearing 16 that enables the lever arm to pivot about a fixed axis. At its opposite end, the lever arm 14 is provided with a return spring 17 that is capable of bending under downward-directed forces issuing from the rotating frame.

It must be understood that the present invention is in no way limited to the embodiments described above and that many modifications can be made thereto without departing from the scope of the accompanying claims.

It would for example be possible to imagine that each bearing arm is a flexible cantilever arm that at one end is connected to a fixed base, for example by an upright, and that, at an opposite end, carries the pivot axis of the roller in a flexible manner.

1. Device supporting a rotating frame (1) for a filtration installation with filtration cells disposed in a carousel, comprising
support rollers (2) that each have a pivot axis (3) and that support the rotating frame so as to allow a rotation of the latter about a rotation axis (13) of the carousel, and
per roller (2), a fixed bearing (11) that supports the roller so as to allow its pivoting, the bearing comprising a first arm (9) and a second arm (10) disposed on each side of the roller (2) in order to carry it so as to allow its pivoting,
characterised in that, according to the forces applied to the roller (2) by the rotating frame (1), the first arm (9) passes from first bending state to a second bending state and vice versa independently of a bending state of the second arm, and respectively the second arm (10) passes from a first bending state to a second bending state and vice versa, independently of the bending state of the first arm.

2. Device according to claim 1, characterised in that each of the arms (9, 10) of a bearing has a first end fixed to a base (12) and a second end that carries the roller (2) and that is situated at a distance from the base, variable according to the said forces applied to the roller.

3. Device according to claim 2, characterised in that each arm (9, 10) of a bearing (11) has the general shape of a U on its side, the said first end and the said second end of which move closer together or further apart according to the said forces applied to the roller.

4. Device according to claim 1, characterised in that each arm of a bearing comprises a first rigid part (15) that carries the roller and a second part (14, 17) that supports the said first part in a flexible manner on a base.

5. Device according to claim 4, characterised in that the second part comprises a lever arm (14) that is connected to the base so as to be able to pivot about a fixed axis and a return spring element (17) that supports the lever arm on the base, at a distance from the fixed axis.

6. Device according to claim 1, characterised in that each arm of the bearing is a flexible cantilever arm that at one end is connected fixedly to a base and at an opposite end carries the roller in a flexible manner.

7. Device according to claim 1, characterised in that each bearing arm carries the roller (2) so as to allow a vertical downward movement of the pivot axis (3) of around 2 mm.

8. Device according to claim 1, characterised in that the pivot axis (3) of the roller is horizontal in the first bending state of the arms (9, 10) of the bearing and in that each bearing arm carries the roller so as to allow a tilting of the pivot axis of around 2o from the horizontal.

9. Device according to claim 1, characterised in that the rollers are cylindrical.

10. Device according to claim 1, characterised in that the rollers are conical.

11. Device according to claim 1, characterised in that the rollers are provided with a tyre made from cast iron, steel or a synthetic material.

12. Device according to claim 1, characterised in that the roller comprises a central roller bearing allowing its pivoting about its pivot axis.
